(19) United States
(12) Patent Application Publication
(10) Pub. No.: US 2010/0072921 A1
(43) Pub. Date: Mar. 25, 2010

(54) Lighting System Utilising RJ45 Patch Lead

(76) Inventor: Richard Weatherley, Northampton (GB)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 12/519,580

(22) PCT Filed: Dec. 18, 2007
(86) PCT No.: PCT/GB2007/004873

§ 371 Date: Jun. 17, 2009

(30) Foreign Application Priority Data
Dec. 19, 2006 (GB) 0625315.7

(51) Int. Cl. H05B 37/02; F21S 4/00; B23P 19/04

(52) U.S. Cl. 315/297; 362/235; 315/294; 29/740

(57) ABSTRACT

A luminaire has an aluminium body with an opening extending longitudinally therethrough from a front face from which, in use, light is emitted, and a rear face to which, in use, a power coupler is connectable. A circuit board is mounted in the body proximate to the front face, which circuit board carries a plurality of LEDs. A power board carrying an RJ45 socket is mounted on the rear face of the body, the power board being electrically connected to the circuit board by a pair of wires. The wires are clipped into wire guides mounted in the body. A lens shroud mounts in the opening in the body in front of the circuit board and is secured in position by screws, the lens shroud having a plurality of cylindrical apertures formed therein corresponding in number and pattern to the number and pattern of LEDs on the circuit board such that each aperture aligns with one of said LEDs, shrouding its associated LED such that the light emitted therefrom is collimated.

This invention relates to a lighting system that uses RJ45 patch leads to connect a luminaire to a power source.

RJ45 patch leads (that is multi-conductor leads having an RJ45 plug attached to each end) are commonly used for data transfer. Such leads, and their associated jacks, are produced each year in vast numbers and, as a consequence, have become very low cost items. Whilst the leads are generally used only in data transfer application, the conductors are capable of carrying a light current load and accordingly the leads can be used for electric current supply.

I now propose a lighting system in which RJ45 patch leads are used as a means of connecting a luminaire to a power supply.

With the advent of high power light emitting diodes (“LEDs”) it has become practicable to produce a luminaire in which the light source is one or more LEDs. Because LEDs have an extremely long service life (typically up to 50,000 hours) luminaires incorporating LEDs may realistically be manufactured without any facility for changing the LEDs. Thus, the possibility exists of producing a luminaire which is a disposable item, or which includes as a disposable item all the electrical and light producing components of the luminaire.

LEDs typically have a forward operating voltage of 3 volts DC and are typically connected in series arrays so that they can be driven by low voltage constant current supplies. (The power usage of each LED is, at most, a few watts.) Thus, the possibility exists of using an RJ45 patch lead to connect a luminaire incorporating LEDs to a power supply—for example a transformer that delivers the required DC output from a mains supply. Using RJ45 patch leads in this manner provides a means for rapidly, reliably, and cheaply installing a lighting system comprising multiple luminaires and a transformer having multiple RJ45 jack outputs.

Additionally, the possibility exists of using detectors in the luminaires to control their operation. For example, a movement detector or an ambient light detector may be incorporated within a luminaire and the output of that detector can be used to control either the individual luminaire, or all connected luminaires. For example, one or more of a group of luminaires may incorporate a movement detector and the luminaires may be linked so that if movement is detected all luminaires in the group are switched on. Similarly, if no movement is detected for a pre-determined period all luminaries in the group may be switched off. The conductors available within a standard RJ45 patch lead facilitate communication of control data between lamps that are connected to a common transformer as well as the supply of power to the individual luminaires. Even in installations when multiple transformers are used, each transformer module may incorporate an uplink jack to enable it to be connected to other transformers by a RJ45 patch lead. Thus, the complex and sophisticated arrangements of lamps may be provided rapidly and at low cost utilizing RJ45 patch leads.

As an alternative to incorporating sensors into luminaries separate free standing sensors may be provided and may be connected to one or more luminaries by RJ45 patch leads, eg via the power supply transformer. Also, control of lighting systems may be effected from a computer or other control device utilizing an RJ45 connection.

According to the present invention there is provided a luminaire comprising a body having an opening extending longitudinally therethrough from a front face from which, in use, light is emitted, and a rear face to which, in use, a power coupler is connectable, a circuit board mounted in the opening proximate to the front face which circuit board carries a plurality of LEDs, a power connector mounted on the rear face of the body, the power connector being electrically connected to the circuit board by conducting means for conducting power thereto for powering the LEDs, and a lens shroud mounted in the opening in the body in front of the circuit board, the lens shroud having a plurality of cylindrical apertures formed therein corresponding in number and pattern to the number and pattern of LEDs on the circuit board such that each aperture aligns with one of said LEDs, shrouding its associated LED such that the light emitted therefrom is collimated.

A luminaire in accordance with the invention has the advantage that the provision of the lens shroud provides a particularly effective control for the light pattern which can easily be changed by changing the shroud for a different one. This can be achieved in a preferable manner if each aperture of the lens shroud has a transparent cover, in the form of a lens on its end which is remote from the circuit board, changing the focal length of the lenses changing the light pattern.

Preferably, a lens cover is removably engageable over the front of the lens shroud, the lens cover including a plurality of through openings corresponding in number and pattern to the apertures in the lens shroud such that each through opening aligns with one of the apertures of the lens shroud, whilst the over conceals fastening means which secure the lens shroud in position.

The lens cover advantageously clips in place by means of clips which engage with the lens shroud.

In a particularly preferred embodiment, a pair of wires extends between and electrically connects the circuit board and the power connector for effecting electrically connection therebetween. A pair of wire guides are then advantageously mounted in the opening in the body, one of said wires being clipped into each of said wire guides, the wires being longer that the space between the circuit board and the power connector in the assembled luminaire such that there are held under compression in the wire guides.

The power connector preferably comprises a power circuit board on which is mounted an RJ45 socket for receiving an RJ45 plug to supply power thereto.

The present invention further provides a method of assembling a luminaire according to the invention, comprising the steps of electrically connecting the conducting means to the circuit board, fastening the circuit board in the opening of the body proximate to the front face thereof with the conducting means extending rearward, securing the lens shroud over the front of the circuit board with the apertures in the lens shroud aligned with the LEDs on the circuit board, securing the lens cover over the front of the lens shroud with the openings therein aligned with the apertures of the lens shroud, electrically connecting the conducting means to the power connector at the rear of the body and fastening the power connector to the rear of the body.

Preferably, the conducting means are connected to the circuit board and power connector respectively by soldering. In a particularly advantageous development, after connecting the conducting means to the circuit board and before securing the circuit board in the body, the conducting means are clipped into wire guides for guiding them longitudinally through the opening in the body.

A further aspect of the invention provides a luminaire comprising a body having a plurality of LEDs mounted in one end of providing illumination and a power connector on the other end of providing power to said LEDs, wherein the power connector including an RJ45 socket such that RJ45 patch leads may be used to connect the luminaire to a power supply.

A still further aspect of the present invention provides a luminaire comprising a body having an opening extending longitudinally therethrough from a front end to a rear end, a first circuit board mounted in the front end on which are mounted a plurality of forward facing LEDs, a second circuit board mounted in the rear end carrying a rear facing connector for supplying power to the luminaire, a pair of wires extending between and electrically connected to the first and second circuit boards for supplying power to the LEDs, and a pair of wire guides provided in the body, each wire being clipped into one of said wire guides, the wires being longer that the separation between the first and second circuit boards such that the wires are held in the wire guides under compression.

Preferably, the wires guides are removably mounted in the body.

A further aspect of the present invention provides a plurality of luminaries according to the invention, at least one power supply and at least one controller box for controlling the operation of the luminaries, wherein interconnection between the or each power supply, the or each controller box and said luminaries is effected by means of RJ45 patch leads.

In a preferred embodiment, a plurality of controller boxes are interconnectable using RJ45 patch leads so as to provide an expandable lighting system. A plurality of detectors for detecting at least one of movement and sound within a monitored region may then advantageously provided, either integrated into the luminaries or as separate units, the or each controller actuating at least one luminaire in response to said detection.

The controllers preferably operate to actuate the or each luminaire at a plurality of different light levels.

The invention will be better understood from the following description of a preferred embodiment thereof, given by way of example only, reference being had to the accompanying drawings, in which:

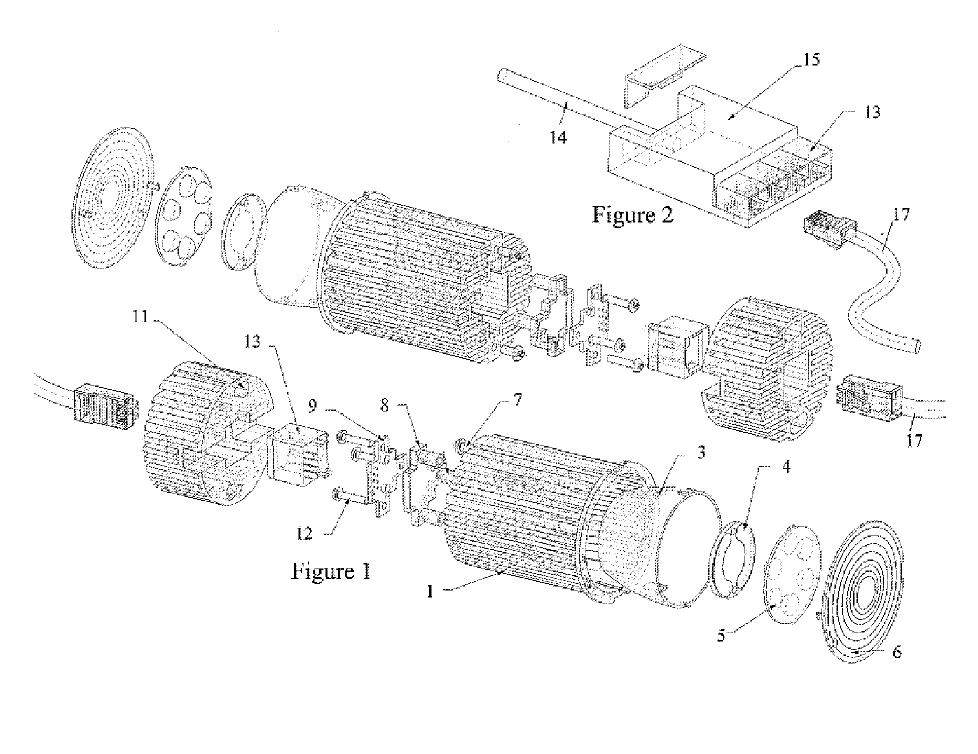

FIG. 1 is an exploded perspective view from both ends of a luminaire according to a first embodiment of the invention;

FIG. 2 is a perspective view of a power transformer suitable for supplying electrical energy to the luminaries;

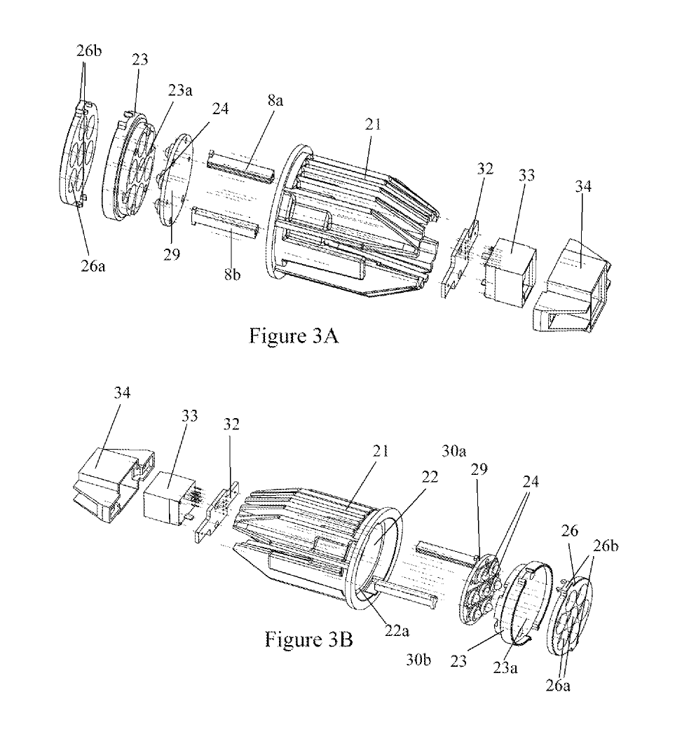

FIG. 3a is an exploded perspective view from a first end of a luminaire according to a second embodiment of the invention;

FIG. 3b is an exploded perspective view from a second end of the luminaire of FIG. 3a;

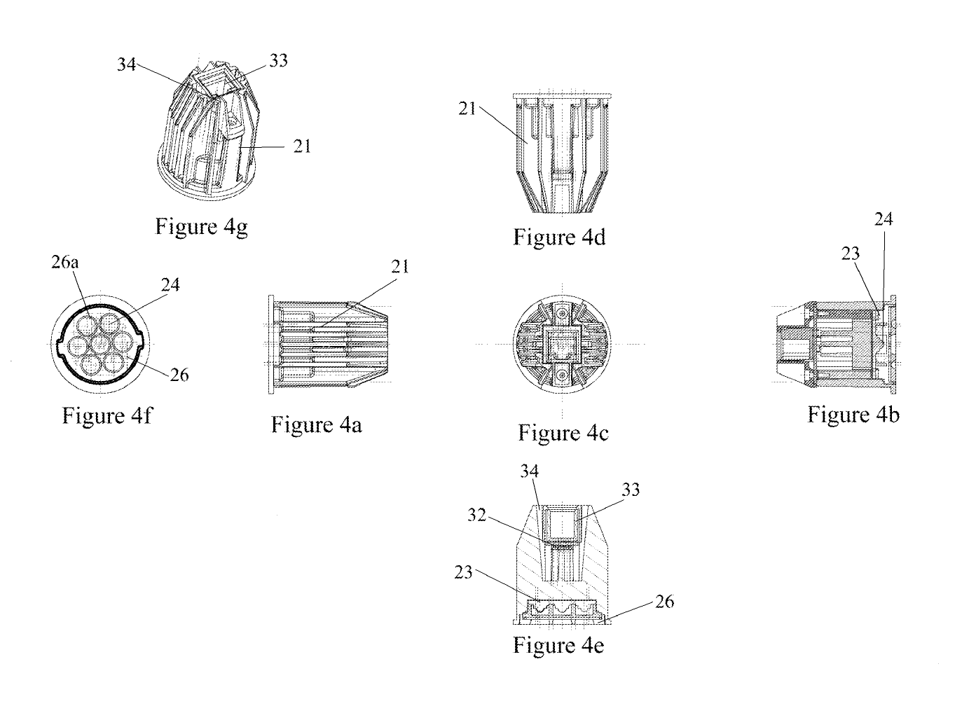

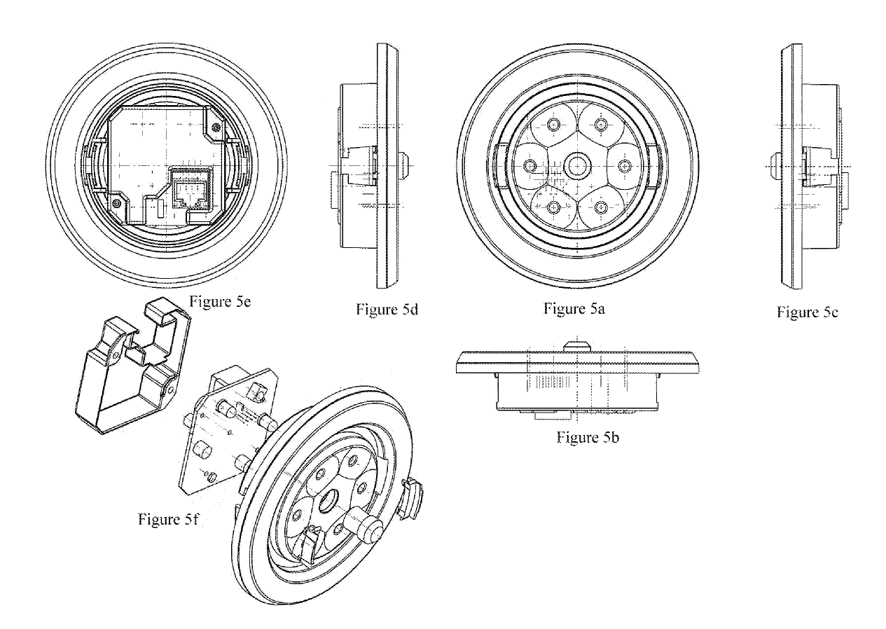

FIG. 4 shows various elevations of a housing portion of the luminaire of FIG. 3a;

FIG. 5 shows various views of a sensor assembly which can be used in conjunction with the present invention. And

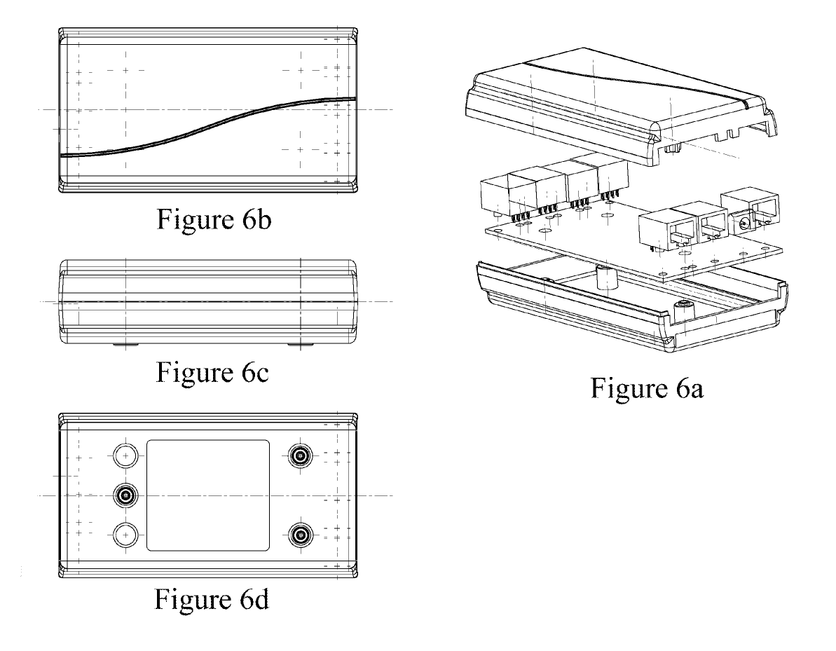

FIG. 6 shows various views of a controller box for use with the invention.

Referring to FIG. 1, each luminaire incorporates an aluminum body 1 that forms a heat sink to prevent the LEDs 4 from overheating. The LED PCB may carry any desired number of LED emitters, (for example, 4, 6 or 10 depending on the power output required and the individual power output of each LED). The emitter carrier is electrically connected to a PCB 9 by rivets 12 which are electrically isolated from the main lamp body by insulators 8 of plastics material. Connection of power from a transformer 15 is achieved using an RJ45 patch lead 17 of suitable length. At each end, RJ45 jacks 13 are provided on the transformer and on each luminaire respectively.

Each luminaire incorporates a reflector 3 and, if desired, a focusing lens 5 which may be tinted. The luminaire may be supplied with a beam spreader 6 which can also be tinted.

If desired, an additional heat sink 11 may be provided for connection to the luminaire by suitable fixings, for example bolts 7. By this means, the heat dissipating ability of the luminaire body may be tailored to the particular power output of the LEDs or the particular installation circumstances of the luminaire.

The transformer 15 provides power to drive the LEDs, and is typically powered via a mains lead 14 which is switched in conventional manner to isolate the luminaires from the power when required.

Referring now to FIGS. 3a and 3b, there is shown an alternative luminaire construction comprising an aluminium body 21 that forms a heat sink for the LEDs 24 as with the previous embodiment. In this arrangement, no reflector is provided—instead the LEDs 24 are mounted on circuit board 29 so as to face towards the open end of the luminaire—the circuit board 29 preventing light from being directed towards the back of the body 21. The circuit board 29 locates in a complementary shaped recess 22 formed in the body 21, engaging against a shoulder 22a which terminates the inner end of the recess 22, and a plurality, in the illustrated example 7, LEDs are mounting of the forward facing surface of the circuit board 29. Although not shown, a thermal gasket is located between the circuit board 29 and the shoulder 22a which assists in the heat transfer from the circuit board 29 to the body 21, and the circuit board 21 is secured in place in the body by use of screws which engage in openings in the body 21.

A lens shroud 23 locates over the circuit board and has a number of elongated tubular apertures 23a formed therein corresponding to the number of LEDs 24 on the circuit board 29, the distribution pattern of the apertures 23a matching the distribution pattern of the LEDs 4 on the circuit board such that when the lens shroud 23 is in position, each aperture 23a aligns with one of the LEDs 24. Each apertures 23a extends over and around its associated LED 24 so as to shroud it, ensuring all light is projected forwards and also collimating the light emitted from the LEDs. Preferably, each apertures extends at least 8 mm so as to optimize the collimation. The forward end of each aperture 23a, remote from the circuit board 29, is closed off by a domed cover (not shown) which acts as a lens, focusing the light so as to control the light pattern from the luminaire. A short focal length for the lenses will produce a tight pattern whereas a long focal length will produce a wide-angle pattern. Alternatively, if preferred, a flat cover may be used to close off each aperture which has no focusing ability and simply act to protect the collimating channels and LEDs 24 from the ingress of dirt. Preferably, the covers are integrally formed with the lens shroud but may optionally be separately formed and attached thereto. The lens shroud is preferably made of polycarbonate.

Screws 25 are used to secure the lens shroud 23 in place. A seal (not shown) is also provided between the lens shroud and the circuit board 29 which avoids water ingress.

To complete the arrangement, a lens cover 26 is provided which fits over the front of the lens shroud 23, concealing the fastening screws of the lens cover from view. This lens cover again has a number of openings 26a in a pattern to match the LEDs so that each opening 26a aligns with one of LEDs 24 and associated lens shroud aperture 23a. The lens cover 26 has a pair of tabs 26b extending radially from diametrically opening sides thereof which are engageable in a snap fit manner in complementary shapes wing openings 23b formed in opposing sides of the lens shroud 23 so as to align and fasten the cover 26 in the shroud. It will, of course, be understood that although illustrated with two fastening tabs 26b on the cover and a correspond pair of wing openings 23b in the shroud 23, any number can be used.

A further development as compared with the first described embodiment is the provision of a pair of wire guides 30a, 30b in the body 21 which assist with the locating of the wires (not shown) that deliver power to the circuit board 29. The wire guides are separately formed from and clip into the body 21 at diametrically opposite sides, and each guide 30a, 30b has a channel or aperture extending longitudinally therethrough in which the associated wire engages.

The end of each guide 30a, 30b which, in use, is proximate to the circuit board 29 furthermore has an opening for receiving a fastening screw 25 of the lens shroud.

The assembly of the second embodiment is assembled by first engaging the wires with solder pads (not shown) provided on the circuit board 29 for effecting electrical contact with the wires and soldering the wires to their respective solder pads. The circuit board is then fitted into the body 21 with the thermal gasket located between the board 29 and the body 21 and the wires clipped into the guides 30a, 30b. The wires may be located in the guides and the guides then clipped into the body 21 or vice-versa. The circuit board 29 is then fastened to the body 21 using the screws, the lens shroud fitted over the circuit board and again fastened in place using screws which engage in the wire guides 30a, 30b and finally the lens cover snapped into place.

A power PCB 32 is provided at the back end of the body 21 on which is connected an RJ45 connector 33. The PCB 32 has two holes for receiving the inner ends of the connecting wires for soldering to the PCB. The wires are longer than the body 21 so as to make soldering easier. Once so connected, the PCB is then screwed to the inner end of the body 21. The extended length of the wires offers the further advantage that when the PCB is fastened to the body 21, the wires are compressed which helps to maintain the integrity of the solder connections as compared with prior art systems where the wires are typically under tension and have a tendency therefore to cause the solder joints to facture over time. Finally, a cover 34 is fastened over the power PCB 32 and RJ45 connector 33. In preferred embodiments of the particular invention the luminaire incorporates one or more detectors, for example a movement detector and/or an ambient light detector. By this means, activation of the luminaire may be controlled in response to ambient light levels and/or detected motion. Further, conductors within the RJ45 patch lead may be used to communicate information from the motion detector and/or ambient light detector to other interconnected luminaires. The detectors may be incorporated into the luminaire assembly or may be formed separately therefrom—an example separately formed detector is illustrated in FIG. 5.

The detectors are connected to a controller unit programmed with software to receive the detector signals and then to operate the luminaries by switching then on, off, dimming or brightening depending on the conditions. The sensors may be responsive to audio signals or motion signals or both within the illuminated area. Preferably, the controller is programmed to dim in 8 steps and has auto light level setting. Multiple controller units are also inter-connectable in a daisy chain manner to expand the system, with one controller being configured as a master and the others operating as slave units therefrom. The use of RJ45 connectors facilitates this system due to the number of data wires present. Different modes may also be chosen to switch off one or other of the audio and movement sensing, and indicators such as LEDs may be used to provide a visual indication of the operating mode currently selected.

1. A luminaire comprising a body having an opening extending longitudinally therethrough from a front face from which, in use, light is emitted, and a rear face to which, in use, a power coupler is connectable, a circuit board mounted in the opening proximate to the front face which circuit board carries a plurality of LEDs, a power connector mounted on the rear face of the body, the power connector being electrically connected to the circuit board by conducting means for conducting power thereto for powering the LEDs, and a lens shroud mounted in the opening in the body in front of the circuit board, the lens shroud having a plurality of cylindrical apertures formed therein corresponding in number and pattern to the number and pattern of LEDs on the circuit board such that each aperture aligns with one of said LEDs, shrouding its associated LED such that the light emitted therefrom is collimated.

2. A luminaire according to claim 1, wherein each aperture of the lens shroud is closed off at its end which is remote from the circuit board by a transparent cover, which is preferably integrally formed with the lens shroud.

3. A luminaire according to claim 2, wherein each said transparent cover is a lens such that the light from each LED is individually focused.

4. A luminaire according to claim 1, further including a lens cover removably engageable over the front of the lens shroud, the lens cover including a plurality of through openings corresponding in number and pattern to the apertures in the lens shroud such that each through opening aligns with one of the apertures of the lens shroud, whilst the over conceals fastening means which secure the lens shroud in position.

5. A luminaire according to claim 4, wherein the lens cover includes clips by means of which it can be clipped to the lens shroud.

6. A luminaire according to claim 1, further comprising a pair of wires electrically connected between the circuit board and the power connector for effecting electrically connection therebetween.

7. A luminaire according to claim 6, wherein a pair of wire guides are mounted in the opening in the body, one of said wires being clipped into each of said wire guides, the wires being longer that the space between the circuit board and the power connector in the assembled luminaire such that there are held under compression in the wire guides.

8. A luminaire according to claim 1, wherein power connector comprises a power circuit board on which is mounted an RJ45 socket for receiving an RJ45 plug to supply power thereto.

9. A method of assembling a luminaire according to claim 1, comprising the steps of electrically connecting the conducting means to the circuit board, fastening the circuit board in the opening of the body proximate to the front face thereof with the conducting means extending rearward, securing the lens shroud over the front of the circuit board with the apertures in the lens shroud aligned with the LEDs on the circuit board, securing the lens cover over the front of the lens shroud with the openings therein aligned with the apertures of the lens shroud, electrically connecting the conducting means to the power connector at the rear of the body and fastening the power connector to the rear of the body.

10. A method according to claim 9, wherein the conducting means are connected to the circuit board and power connector respectively by soldering.

11. A method according to claim 9 or claim 10, wherein after connecting the conducting means to the circuit board and before securing the circuit board in the body, the conducting means are clipped into wire guides for guiding them longitudinally through the opening in the body.

12. A luminaire comprising a body having a plurality of LEDs mounted in one end of providing illumination and a power connector on the other end of providing power to said LEDs, wherein the power connector including an RJ45 socket such that RJ45 patch leads may be used to connect the luminaire to a power supply.

13. A luminaire comprising a cylindrical body having an opening extending longitudinally therethrough from a front end to a rear end, a first circuit board mounted in the front end on which are mounted a plurality of forward facing LEDs, a second circuit board mounted in the rear end carrying a rear facing connector for supplying power to the luminaire, a pair of wires extending between and electrically connected to the first and second circuit boards for supplying power to the LEDs, and a pair of wire guides provided in the body, each wire being clipped into one of said wire guides, the wires being longer that the separation between the first and second circuit boards such that the wires are held in the wire guides under compression.

14. A luminaire according to claim 13, wherein the wires guides are removably mounted in the body.

15. A lighting system comprising a plurality of luminaries according to claim 1, at least one power supply and at least one controller box for controlling the operation of the luminaries, wherein interconnection between the or each power supply, the or each controller box and said luminaries is effected by means of RJ45 patch leads.

16. A lighting system according to claim 15, wherein a plurality of controller boxes are interconnectable using RJ45 patch leads so as to provide an expandable lighting system.

17. A lighting system according to claim 15, further including a plurality of detectors for detecting at least one of movement and sound within a monitored region, the or each controller actuating at least one luminaire in response to said detection.

18. A lighting system according to claim 15, wherein the or each controller is operable to actuate the or each luminaire at a plurality of different light levels.
